(19) United States
(12) Patent Application Publication
(10) Pub. No.: US 2026/0169765 A1
(43) Pub. Date: Jun. 18, 2026

(54) DEVICE, SYSTEM, AND METHOD FOR VISUALLY DISTINGUISHING DISCREPANCIES BETWEEN DISCRETE BLOCKS OF AUDIO STREAMS AND ASSOCIATED TRANSCRIPTIONS

(71) Applicant: MOTOROLA SOLUTIONS, INC., Chicago, IL (US)

(72) Inventors: Lindsey R. TRYBAN, Schaumburg, IL (US); Elijah David HOON, Elgin, IL (US); Theodore S. LIETZ, Schaumburg, IL (US); Abishek KANNAN, Vernon Hills, IL (US); Peter L. HANDLER, Buffalo Grove, IL (US)

(21) Appl. No.: 18/982,598

(22) Filed: Dec. 16, 2024

(51) Int. Cl. G06F 9/451; G06F 40/205; G10L 15/26; H04S 7/00

(52) U.S. Cl. CPC G06F 9/451; G06F 40/205; G10L 15/26; H04S 7/30

(57) ABSTRACT

A computing device concurrently handles audio streams, transcribes the audio streams, and parses the audio streams and associated transcriptions into discrete blocks. The computing device identifies, within the discrete blocks, information associated with an incident, and compares the information with manually received incident data to identify discrepancies therebetween. The computing device provides, at a display screen, respective visual indications of respective discrete blocks of the audio streams, and visually distinguishes, at the display screen, the respective visual indications of the respective discrete blocks of the audio streams associated with the discrepancies from other discrete blocks not associated with the discrepancies.

### BACKGROUND OF THE INVENTION

Speech-to-text technologies, even when artificial intelligence based, are subject to error. When transcriptions of audio streams are provided at a public-safety answering point terminal, for example in public safety and/or first responder environments, such errors may lead to significant waste in processing resources in trying to correct such errors. Similarly, dispatchers listening to audio streams may be attempting to take electronic notes from a plurality of audio streams and, as such dispatchers are generally listening to many audio streams at once, these manual notes may also be prone to error, which may also lead to significant waste in processing resources in trying to correct such errors.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system for visually distinguishing discrepancies between discrete blocks of audio streams and associated transcriptions, in accordance with some examples.

FIG. 2 is a device diagram showing a device structure of a computing device for visually distinguishing discrepancies between discrete blocks of audio streams and associated transcriptions, in accordance with some examples.

FIG. 3 is a flowchart of a method for visually distinguishing discrepancies between discrete blocks of audio streams and associated transcriptions, in accordance with some examples.

FIG. 4 depicts an example of discrete blocks of an audio stream being generated, in accordance with some examples.

FIG. 5 depicts an example of the discrete blocks of FIG. 4 being compared to manually received incident data, in accordance with some examples.

FIG. 6 depicts an example of respective visual indications of respective discrete blocks of the audio streams being provided at a display screen of a terminal of the system of FIG. 1, when discrepancies occur with the manually received incident data, in accordance with some examples.

FIG. 7 depicts an example of respective visual indications of the respective discrete blocks of the audio streams being provided at a display screen of a terminal of the system of FIG. 1, after the discrepancies with the manually received incident data are resolved, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

At public-safety answering points, dispatchers are often required to monitor many simultaneous audio streams at their terminals, such as audio streams from 911 callers, and first responders. Indeed, in some instances, the dispatchers may be required to listen to as many as ten audio streams at once, and take electronic notes via a terminal. The high volume and overlapping nature of these audio streams present significant challenges in recording details in such electronic notes. While speech-to-text technologies are available to assist in transcription of audio streams, such speech-to-text technologies may be subject to errors. Indeed, such errors in both electronic notes and speech-to-text transcriptions subject to errors, may lead to significant waste in processing resources and/or bandwidth resources and/or electronic dispatching errors at public-safety answering points, as, for example, when first responders are dispatched on the basis of such errors, processing resources, bandwidth resources and electronic dispatching resources are used to correct the errors. Furthermore, decisions made from the transcriptions and/or the notes may cause first responders to be dispatched on the basis of such errors, leading to significant waste in processing resources, bandwidth resources and electronic dispatching resources to correct erroneous dispatch decisions. Thus, there exists a need for an improved technical method, device, and system for visually distinguishing discrepancies between discrete blocks of audio streams and associated transcriptions.

An aspect of the present specification provides a method comprising: concurrently handling, via a call-handling device, audio streams, the call-handling device communicatively coupled to a display screen, and an input device; transcribing, via the call-handling device, the audio streams; parsing, via the call-handling device, the audio streams and associated transcriptions into discrete blocks; identifying, via the call-handling device, within the discrete blocks, information associated with an incident; comparing, via the call-handling device, the information and manually received incident data to identify discrepancies therebetween; providing, via the call-handling device, at the display screen, respective visual indications of respective discrete blocks of the audio streams; and visually distinguishing, via the call-handling device, at the display screen, the respective visual indications of the respective discrete blocks of the audio streams associated with the discrepancies from other discrete blocks not associated with the discrepancies.

Another aspect of the present specification provides a computing device (e.g., and/or a call-handling device) comprising: a controller communicatively coupled to a display screen, and an input device; and a computer-readable storage medium having stored thereon program instructions that, when executed by the controller, causes the controller to perform a set of operations comprising: concurrently handling audio streams; transcribing the audio streams; parsing the audio streams and associated transcriptions into discrete blocks; identifying, within the discrete blocks, information associated with an incident; comparing the information and manually received incident data to identify discrepancies therebetween; providing, at the display screen, respective visual indications of respective discrete blocks of the audio streams; and visually distinguishing, at the display screen, the respective visual indications of the respective discrete blocks of the audio streams associated with the discrepancies from other discrete blocks not associated with the discrepancies.

Each of the above-mentioned aspects will be discussed in more detail below, starting with example system and device architectures of the system, in which the embodiments may be practiced, followed by an illustration of processing blocks for achieving an improved technical method, device, and system for visually distinguishing discrepancies between discrete blocks of audio streams and associated transcriptions.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram. It is contemplated that any part of any aspect or embodiment discussed in this specification can be implemented or combined with any part of any other aspect or embodiment discussed in this specification.

As used herein, the term “engine” refers to hardware (e.g., a processor, such as a central processing unit (CPU), graphics processing unit (GPU), a tensor processing unit (TPU), or similar parallel processing units optimized for handling large-scale data and complex machine learning models, an integrated circuit or other circuitry) or a combination of hardware and software (e.g., programming such as machine-or processor-executable instructions, commands, or code such as firmware, a device driver, programming, object code, etc. as stored on hardware). Hardware includes a hardware element with no software elements such as an application specific integrated circuit (ASIC), a Field Programmable Gate Array (FPGA), a PAL (programmable array logic), a PLA (programmable logic array), a PLD (programmable logic device), etc.

Further advantages and features consistent with this disclosure will be set forth in the following detailed description, with reference to the drawings.

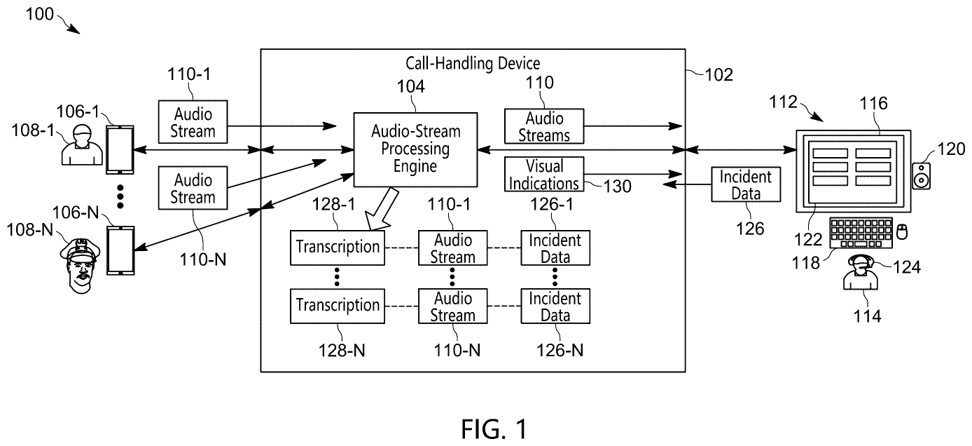

Attention is directed to FIG. 1, which depicts an example system 100 for visually distinguishing discrepancies between discrete blocks of audio streams and associated transcriptions. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links and/or wireless and/or wired communication networks, and the like.

The system 100 comprises a call-handling device 102, which may be a component of a public-safety answering point (PSAP). As depicted, the call-handling device 102 is implementing an audio-stream processing engine 104, that may process calls to the call-handling device 102 and/or assist with calls to the call-handling device 102 (or calls from the call-handling device 102), for example to transcribe such calls and compare such transcriptions to manually received incident data, as described herein.

Put another way, as depicted, the call-handling device 102 may be configured as a device, and/or a proxy device, for answering calls from a plurality of communication devices 106-1 . . . 106-N operated by respective users 108-1 . . . 108-N. For simplicity, the plurality of communication devices 106-1 . . . 106-N are interchangeably referred to hereafter, collectively, as the communication device 106 and, generically, as a communication device 106. This convention will be used throughout the present specification. For example, the users 108-1 . . . 108-N are interchangeably referred to hereafter as the users 108 and/or a user 108.

In general, the number “N” of the communication devices 106 may be any suitable number, though herein the number “N” of the communication devices 106 may comprise a number that a dispatcher of the PSAP may be communicating with simultaneously, as will be later described. In such examples, the number “N” of the communication devices 106 may be at least two and may, in some examples, be as high as ten, though the number “N” of the communication devices 106 that a dispatcher of the PSAP may be communicating with simultaneously may be any suitable number (e.g., higher than ten or less than ten, but may be as few as two) that may be set by an administrator of the PSAP. It is understood, however, that a number of communication devices 106 making calls to the call-handling device 102 may be in the hundreds to thousands, or higher.

As depicted, the user 108-1 may comprise a member of the general public operating the respective communication device 106-1 to place a call to the call-handling device 102 using an emergency number such as “911” to report an incident, a mental health number such as “988” to talk about a mental health issue, and the like.

In contrast, the user 108-N may comprise a first responder (e.g., as depicted a police officer) operating the respective communication device 106-N to place a call to the call-handling device 102 to speak to a dispatcher. Alternatively or in addition, such call may be initiated by a dispatcher to the respective communication device 106-N.

The call-handling device 102 may comprise any suitable combination of one or more servers, one or more cloud computing devices, and the like.

The communication devices 106 may comprise any suitable communication devices including, but not limited to, mobile phones, cell phones, first responder radios, laptops, personal computers, and the like, and/or any suitable communication devices that may communicate with components of a PSAP using audio streams as described herein.

For example, the call-handling device 102 is generally handling a plurality of audio streams 110-1 . . . 110-N (e.g., audio streams 110 and/or an audio stream 110) that may be received at the call-handling device 102 and processed by the audio-stream processing engine 104, as described herein, and which may otherwise be provided to a terminal 112 operated by a dispatcher 114.

The terminal 112 may comprise a PSAP call answering terminal, and the like, and may comprise any suitable combination of input and output devices that enable the dispatcher 114 to listen to the audio streams 110 and/or speak to the users 108.

As depicted, the terminal 112 comprises a display screen 116, an input device 118 (e.g., as depicted, keyboard, as depicted, a pointing device and/or any other suitable input device) and a speaker 120. However, the terminal 112, the display screen 116, the input device 118, and the speaker 120 may be provided in any suitable format, such as a laptop, a personal computer, and the like (e.g., when the dispatcher 114 is working from home and/or “off-premises” from a PSAP). In general, the display screen 116 and the input device 118 may be used to interact with the terminal 112, for example via an interface 122 (which may include, but is not limited to, a VR interface) provided at the display screen 116, and the like. The terminal 112 is further understood to comprise a communication device, for example as represented in FIG. 1 by a headset 124 worn by the dispatcher 114, that may enable the dispatcher 114 to communicate with the communication devices 106 (e.g., and hence the users 108), as the headset 124 generally comprises a combination of a speaker and a microphone. Indeed, while the speaker 120 is depicted as external to the headset 124, in other examples the speaker 120 may be a component of the headset 124.

It is further understood that the dispatcher 114 may be listening to the audio streams 110 simultaneously, but may operate the terminal 112 to talk to individual users 108 via the communication devices 106.

In particular, the audio streams 110 may be associated with respective incidents that the users 108 are reporting and/or to which they are responding. While more than one audio stream 110 may be associated with a same incident, for simplicity herein it is assumed that the audio streams 110 are associated with different incidents and that the dispatcher 114 is manually recording incident data 126-1 . . . 126-N (e.g., sets of incident data 126 and/or a set of incident data) associated with the different incidents and/or respective audio streams 110. For example, the dispatcher 114 may operate the terminal 112 to generate the manually received incident data 126 in association with different audio streams 110, which, as depicted, is provided to the call-handling device 102. As the manually received incident data 126 is understood to be at least manually generated, and received at the call-handling device 102 (e.g., and/or the terminal 112), the manually received incident data 126 is hereafter referred to as manually received incident data 126.

It is further understood that the call-handling device 102 is generally enabled to associate the different sets of incident data 126 with respective audio streams 110 (e.g., via indications of such associations that may be stored with the manually received incident data 126, as provided by the terminal 112 and/or the dispatcher 114 via the terminal 112).

The manually received incident data 126 may be stored at the call-handling device 102 and/or a memory and/or database (not depicted) communicatively coupled with the call-handling device 102. Regardless, the manually received incident data 126 is available to the call-handling device 102.

As depicted, the audio streams 110 are further depicted as being stored in association with the manually received incident data 126, by way of broken lines between sets of incident data 126 and respective audio streams 110.

Put another way, a first audio stream 110-1, received from the communication device 106-1, is stored in association with a first set of manually received incident data 126-1, and an N^{th} audio stream 110-N, received from the N^{th} communication device 106-N, is stored in association with an N^{th} set of manually received incident data 126-N. As such, it is understood that the call-handling device 102 provides the audio streams 110 “live” to the terminal 112, and may also record the audio streams 110 and store the recorded audio streams 110 in association with the manually received incident data 126.

Herein, the term “incident” may refer to a public-safety incident that a user 108 may be calling to report, and/or to which a first responder user 108 may be responding, and may include but is not limited to, police incidents, fire incidents, medical incidents, and the like. As such, while the user 108-N is depicted as a police officer, the user 108-N may comprise any suitable first responder, including, but not limited to, the depicted police officer, a fire fighter, an emergency medical technician (EMT), and the like.

The audio streams 110 are understood to comprise voice data and/or audio data of the various users 108 speaking. In general, the audio-stream processing engine 104 may be generally configured to transcribe the audio streams 110 into transcriptions of the users 108 speaking, and, as such, the audio-stream processing engine 104 is understood to comprise a voice-to-text engine and/or a speech-to-text engine, and the like.

For example, as depicted, the audio-stream processing engine 104 has generated (and/or is generating, as represented by a hollow arrow extending from the audio-stream processing engine 104), respective transcriptions 128-1 . . . 128-N (e.g., transcriptions 128 and/or a transcription 128) of respective audio streams 110-1 . . . 110-N. Furthermore, the audio streams 110 may be stored as received and/or updated as more of a particular audio stream 110 is received, with a respective transcription 128 updated accordingly.

Hence, the audio streams 110 are further depicted as being stored in association with respective transcriptions 128, by way of broken lines between an audio stream 110 and a respective transcription 128. In particular, an audio stream 110 is understood to be associated with a respective transcription 128 and a respective set of manually received incident data 126, and, similarly, the respective transcription 128 and the respective set of manually received incident data 126 are associated with each other.

The transcriptions 128 may also be stored at a memory and/or database at which the audio streams 110 and associated incident data 126 are stored.

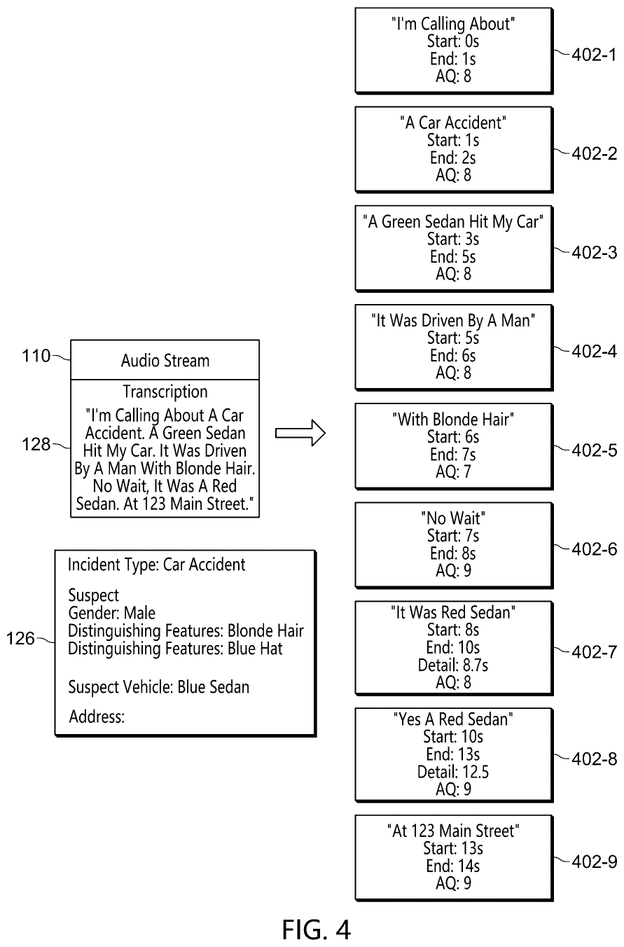

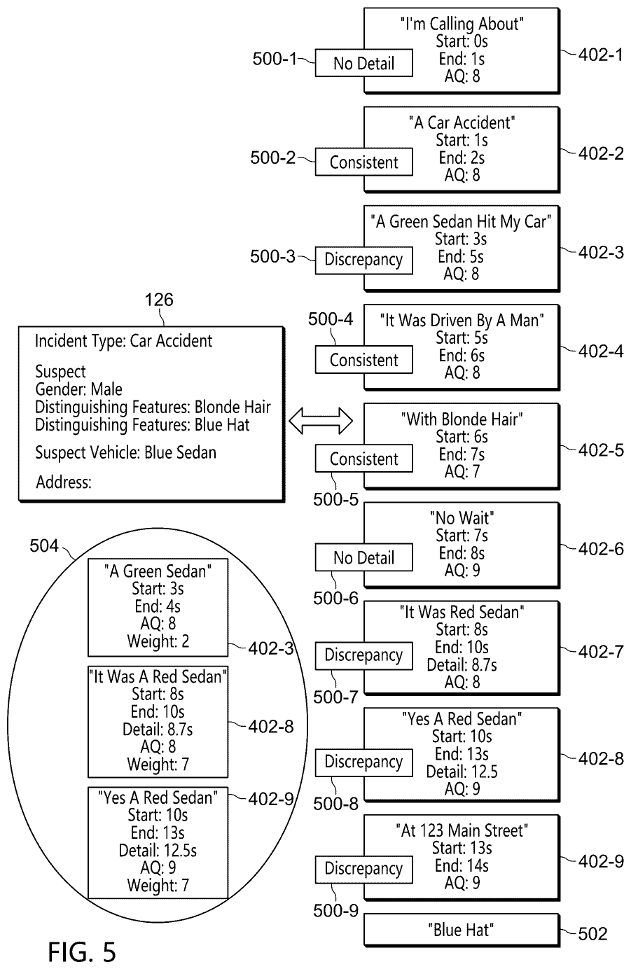

The audio-stream processing engine 104 may further parse the audio streams 110 (e.g., as received and/or as stored) and associated transcriptions 128 into discrete blocks. Such discrete blocks may comprise words and/or phrases that may identify specific information associated with an incident, such as an address (e.g., a street address) associated with an incident, an object associated with an incident, a person associated with an incident, and the like. Examples of discrete blocks are described with respect to FIG. 4 and FIG. 5.

Such a parsing of the audio streams 110 and associated transcriptions 128 into discrete blocks may occur via a natural language processing (NLP) engine, and the like, which may be a component of the audio-stream processing engine 104.

Hereafter, reference will be made to features of discrete blocks that indicate specific information associated with an incident. Some discrete blocks may comprise one respective feature, whereas other discrete blocks may comprise two or more respective features. Such features may also be referred to as details herein.

It is understood that a discrete block may comprise a data structure that includes associated text of a respective transcription 128, and may include, for example, respective time stamps of a start and end to an associated portion of an audio stream 110 that includes audio of a user 108 saying the associated text of a respective transcription 128. A discrete block may further include, but is not limited, to a length of time between the start and end to the associated portion of the audio stream 110, a weight (derived from a weighting scheme, as described in more detail below), pointers and/or time stamps identifying where audio of a user 108 saying the associated text indicating a given feature and/or detail is located, amongst other possibilities.

For example, a discrete block for a given audio stream 110 may comprise text indicating a description of a suspect spoken by a respective user 108 in the given audio stream 110, time stamps indicating the length of portion of the given audio stream 110 where the description is mentioned, a time stamp indicating where the description is mentioned in the portion of the given audio stream 110, as well as text of any other features spoken by the user 108 portion of the given audio stream 110 where the description is mentioned as well, amongst other possibilities.

The audio-stream processing engine 104 may identify within the discrete blocks, information associated with an incident (e.g., a respective incident) such as the specific information (e.g., feature) associated with an incident, and compare the information with respective manually received incident data 126 to identify discrepancies therebetween.

For example, a discrete block may identify a description of a suspect spoken by a respective user 108, and an associated set of manually received incident data 126 may also identify a description of a suspect heard by the dispatcher 114 when listening to a respective audio stream 110. For example, in some instances the description identified by a discrete block and the description of a manually received incident data 126 may be the same, whereas in other instances a description of a suspect identified by a discrete block and the description of a manually received incident data 126 may be different. When different, audio-stream processing engine 104 may identify a discrepancy therebetween.

As depicted, the audio-stream processing engine 104 and/or the call-handling device 102 may provide to the terminal 112, and more specifically to the display screen 116, respective visual indications 130 of respective discrete blocks of the audio streams 110, and furthermore, visually distinguish, at the display screen 116, the visual indications 130 of the respective discrete blocks of the audio streams 110 associated with the discrepancies from other discrete blocks not associated with discrepancies.

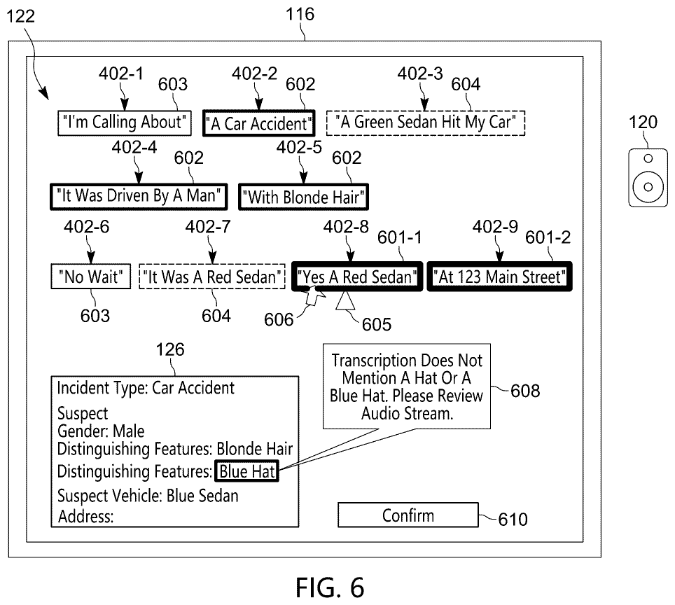

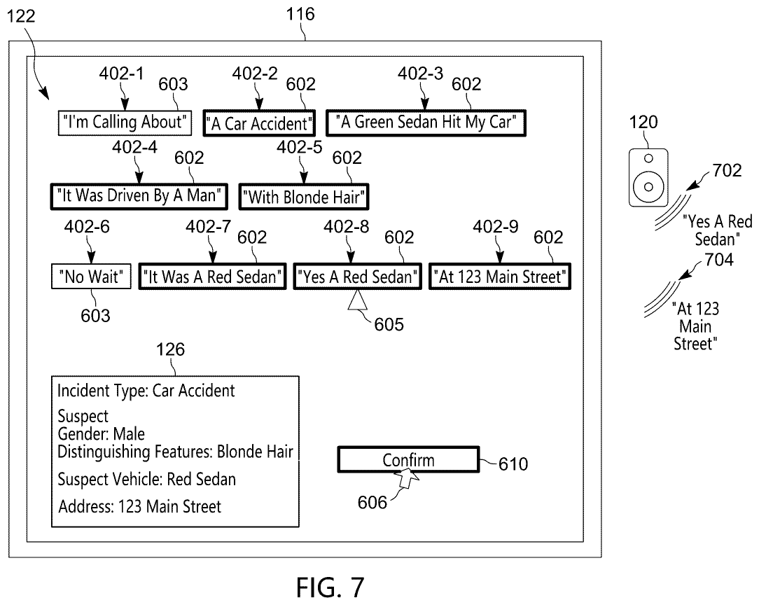

For example, at the display screen 116, a portion of a respective transcription 128 of an audio stream may be provided, such as sections of text of a transcription 128, and discrete blocks within the sections of text may be visually identified in any suitable manner using colors, boxes, shading, and the like. In particular, respective discrete blocks of the audio streams 110 associated with discrepancies are visually distinguished from other discrete blocks not associated discrepancies. Examples of such visual distinctions are described below with respect to FIG. 6 and FIG. 7.

In some examples, the visual indications 130 of the respective discrete blocks of the audio streams 110 may be provided at the display screen 116 as respective electronic buttons and, when input is received at an electronic button of a given discrete block associated with a discrepancy, such as via the input devices 118 (e.g., the dispatcher 114 may “click” on an electronic button using a mouse of the input device 118), associated audio from an audio stream 110 may be played at the speaker 120, so that the dispatcher 114 may listen to the associated audio.

Again using a description of a suspect as an example, a description of a suspect of a discrete block may be different from a description of a suspect in a respective set of manually received incident data 126, and hence the description of a suspect in the transcription 128 of the audio stream 110 may be rendered at the display screen 116 as a text with a box around the text that visually indicates a discrepancy with the description of a suspect. For example, the dispatcher 114 may have erred in manually transcribing the description of a suspect when listening to a respective audio stream 110, or the audio-stream processing engine 104 may have erred when transcribing the description of a suspect in a transcription 128 of the respective audio stream 110.

Hence, when input is received at an electronic button corresponding to a given discrete block that includes the description of a suspect, the portion of the audio stream 110 that includes the description of a suspect may be played at the speaker 120 so that the dispatcher 114 may confirm the description of a suspect. Presuming the manually received incident data 126 was incorrect (e.g., as error rates in manually transcribed information may be higher than error rates in voice-to-text engines), the dispatcher 114 may update manually received incident data 126 to correct the description of a suspect.

As such, after playing the associated audio, the audio-stream processing engine 104 may again compare the information associated with the given discrete block with the manually received incident data 126 and, when the discrepancy between the information associated with the given discrete block and the manually received incident data has been resolved, a visual indication 130 of the given discrete block at the display screen 116 may be changed to indicate that the discrepancy is no longer present, for example by way of again providing a visual indication 130 to the display screen 116.

Alternatively, presuming the manually received incident data 126 was correct, and the information associated with the given discrete block as provided at the display screen 116 was incorrect, the dispatcher 114 may operate the input device 118 to indicate that the manually received incident data 126 is correct, and an indication of such may be stored with the manually received incident data 126. In such examples, the information at the discrete block may be changed to indicate that the discrepancy has been resolved by way of again providing a visual indication 130 to the display screen 116.

In this manner, errors in information associated with an incident may be corrected, which may generally lead to reductions in dispatch errors and the like, leading to overall reductions in use of processing resources and/or bandwidth resources in the system 100.

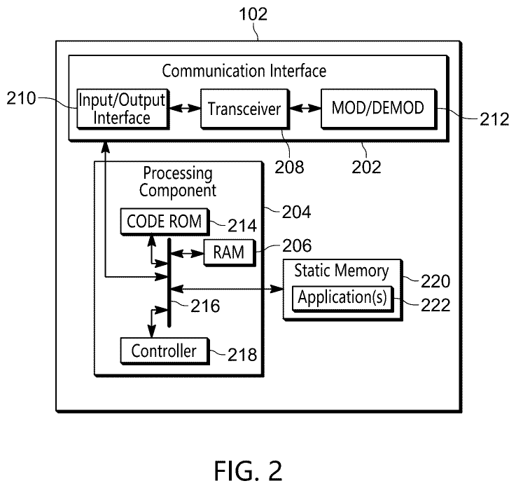

Attention is next directed to FIG. 2, which depicts a schematic block diagram of an example of the call-handling device 102. While the call-handling device 102 is depicted in FIG. 2 as a single component, functionality of the call-handling device 102 may be distributed among a plurality of components and the like including, but not limited to, any suitable combination of one or more servers, one or more cloud computing devices, and the like.

As depicted, the call-handling device 102 comprises: a communication interface 202, a processing unit 204, a Random-Access Memory (RAM) 206, one or more wireless transceivers 208 (e.g., which may be optional), one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the call-handling device 102 may have any suitable structure and/or configuration.

While not depicted, the call-handling device 102 may include, and/or be in communication with, one or more of an input device and a display screen (and/or any other suitable notification device) and the like, such as the input device 118 and/or the display screen 116 of the terminal 112, and the like.

As shown in FIG. 2, the call-handling device 102 includes the communication interface 202 communicatively coupled to the common data and address bus 216 of the processing unit 204.

The processing unit 204 may include the code Read Only Memory (ROM) 214 coupled to the common data and address bus 216 for storing data for initializing system components. The processing unit 204 may further include the controller 218 coupled, by the common data and address bus 216, to the Random-Access Memory 206 and the static memory 220.

The communication interface 202 may include one or more wired and/or wireless input/output (I/O) interfaces 210 that are configurable to communicate with other components of the system 100. For example, the communication interface 202 may include one or more wired and/or wireless transceivers 208 for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

It is understood that the DMR transceivers, P25 transceivers, and TETRA transceivers may be particular to first responder devices, and hence such transceivers may be used to communicate with communication devices 106 that comprise first responder devices and/or radios, and the like.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may be implemented as a plurality of processors, one or more multi-core processors, or specialized hardware accelerators such as Graphics Processing Units (GPUs), Tensor Processing Units (TPUs), or similar parallel processing units optimized for handling large-scale data and complex machine learning models. The controller 218 may be configured to execute different programming instructions, including those optimized for artificial intelligence and/or machine learning tasks as described herein. Alternatively, or in addition, the controller 218 may include one or more ASIC (application-specific integrated circuits) and one or more FPGA (field-programmable gate arrays), and/or another electronic device.

In some examples, the controller 218 and/or the call-handling device 102 is not a generic controller and/or a generic device, but a device specifically configured to implement functionality for visually distinguishing discrepancies between discrete blocks of audio streams and associated transcriptions 128. For example, in some examples, the call-handling device 102 and/or the controller 218 specifically comprises a computer executable engine (e.g., such as the audio-stream processing engine 104) configured to implement functionality for visually distinguishing discrepancies between discrete blocks of audio streams and associated transcriptions 128.

The static memory 220 comprises a non-transitory machine readable medium that stores machine readable instructions to implement one or more programs or applications. Example machine readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine readable instructions) that implement the functionality of the call-handling device 102 as described herein are maintained, persistently, at the memory 220 and used by the controller 218, which makes appropriate utilization of volatile storage during the execution of such programming instructions.

The application 222 may further comprise one or more sets of programming instructions that, when executed by the controller 218, enables the controller 218 to implement the audio-stream processing engine 104.

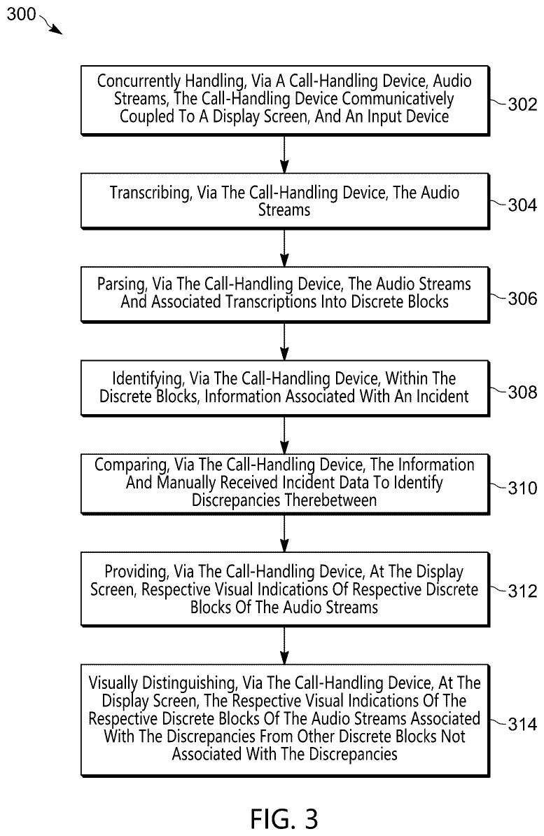

Regardless, it is understood that the memory 220 stores instructions corresponding to the at least one application 222 that, when executed by the controller 218, enables the controller 218 to implement functionality for visually distinguishing discrepancies between discrete blocks of audio streams and associated transcriptions 128, including, but not limited to, the blocks of the method set forth in FIG. 3.

The instructions corresponding to the at least one application 222 may further enable the controller 218 to implement an NLP engine and/or algorithm, and/or a semantic similarity analysis engine and/or algorithm.

The application 222 may include programmatic algorithms, and the like, to implement functionality as described herein.

Alternatively, and/or in addition, application 222 may include one or more machine learning algorithms for example for implementing a voice-to-text engine at the audio-stream processing engine. Such one or more machine learning algorithms may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, and the like. Any suitable machine learning algorithm and/or deep learning algorithm and/or neural network is within the scope of present examples.

While details of the communication devices 106 and the terminal 112 are not depicted, the communication devices 106 and the terminal 112 may have components similar to the call-handling device 102 adapted, however, for the functionality thereof, as described herein.

Attention is now directed to FIG. 3, which depicts a flowchart representative of a method 300 for visually distinguishing discrepancies between discrete blocks of audio streams and associated transcriptions 128. The operations of the method 300 of FIG. 3 correspond to machine readable instructions that are executed by the call-handling device 102, and specifically the controller 218 of the call-handling device 102. In the illustrated example, the instructions represented by the blocks of FIG. 3 are stored at the memory 220 for example, as the application 222. The method 300 of FIG. 3 is one way that the controller 218 and/or the call-handling device 102 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” The method 300 of FIG. 3 may be implemented on variations of the system 100 of FIG. 1, as well.

It is further understood in the following description that the call-handling device 102 communicatively coupled to at least the display screen 116, and the input device 118.

At a block 302, the controller 218, and/or the call-handling device 102, concurrently handles the audio streams 110 (e.g., via the communication interface 202).

For example, such handling of the audio streams 110 may include, but is not limited to, receiving or making calls in which the audio streams 110 are received (e.g., from or to the communication devices 106), answering received calls and/or forwarding such calls to the terminal 112.

At a block 304, the controller 218, and/or the call-handling device 102, transcribes the audio streams 110.

For example, such transcribing may occur using the audio-stream processing engine 104 and/or any suitable voice-to-text engine, and the like.

Indeed, the remainder of the method 300 may occur using the audio-stream processing engine 104, and the like.

At a block 306, the controller 218, and/or the call-handling device 102, parses the audio streams 110 and associated transcriptions 128 into discrete blocks.

At a block 308, the controller 218, and/or the call-handling device 102, identifies, within the discrete blocks, information associated with an incident.

At a block 310, the controller 218, and/or the call-handling device 102, compares the information and manually received incident data 126 to identify discrepancies therebetween.

At a block 312, the controller 218, and/or the call-handling device 102, provides, at the display screen, respective visual indications 130 of the respective discrete blocks of the audio streams 110.

At a block 314, the controller 218, and/or the call-handling device 102, visually distinguishes, at the display screen 116, the respective visual indications 130 of the respective discrete blocks of the audio streams 110 associated with the discrepancies from other discrete blocks not associated with the discrepancies.

The method 300 may include other features.

For example, it is understood that the call-handling device 102 may be further communicatively coupled to the speaker 120 and the method 300 may further comprise, the controller 218, and/or the call-handling device 102: providing the visual indications 130 of the respective discrete blocks of the audio streams 110 at the display screen 116 as respective electronic buttons; when input is received at an electronic button of a given discrete block associated with a discrepancy, playing, at the speaker 120, associated audio from an audio stream 110 at the speaker 120; and, after playing the associated audio, again comparing the information associated with the given discrete block with the manually received incident data 126, and when the discrepancy between the information associated with the given discrete block and the manually received incident data 126 has been resolved, controlling the visual indication 130 of the given discrete block at the display screen 116 to change to indicate that the discrepancy is no longer present.

Alternatively, or in addition, the method 300 may further comprise, the controller 218 and/or the call-handling device 102: when a subset of the respective discrete blocks is associated with a same discrepancy with the manually received incident data 126, selecting one discrete block of the subset to represent the subset as having the same discrepancy; and visually distinguishing, at the display screen 116, an indication of the selected discrete block of the subset from other discrete blocks of the subset.

For example, on an audio stream 110 a same suspect or a same object may be mentioned more than once (e.g., a same feature may be mentioned). In a particular example, an audio stream 110 may include audio that mentions a “red sedan” more than once, and the controller 218 and/or the call-handling device 102 may generate a respective discrete block for each mention of the “red sedan”. However, an associated set of manually received incident data 126 may erroneously include text “blue sedan”. Hence, each discrete block corresponding to a “red sedan” may be determined to have a discrepancy with the associated manually received incident data 126. Such a subset of a plurality of discrete blocks associated with a same discrepancy may be referred to as a cluster hereafter for simplicity.

However, in some examples, a cluster of discrete blocks associated with a same discrepancy may include a feature of the discrete blocks of the cluster being referred to in different ways. For example, again using the example of manually received incident data 126 including an erroneous mention of a “blue sedan”, some of the discrete blocks of a cluster may be associated with audio that mentions a “red sedan” whereas other discrete blocks of the cluster may be associated with audio that mentions a “green sedan”. In this example, both the terms “red sedan” and “green sedan” cause a discrepancy with the erroneous “blue sedan”. Hence, herein, reference to a same discrepancy may refer to discrepancies with a particular item mentioned in manually received incident data 126, though the features of the discrete blocks of the cluster may not be identical. An example of clusters is described with respect to FIG. 5.

If all of the discrete blocks of a cluster were visually distinguished in the same manner at the display screen 116, visual confusion may occur. As such, in these examples, rather than visually distinguish all of the discrete blocks of a cluster at the display screen 116, one discrete block may be selected and visually distinguished, whereas other discrete blocks of the cluster may not be otherwise visually distinguished, or may be visually distinguished from the selected discrete block. In a simple example, a selected discrete block of the cluster may be enclosed by a box of solid lines, and other discrete blocks of the cluster may be enclosed by a box of dashed lines.

Put another way, in some of these examples where a subset of the respective discrete blocks is associated with a same discrepancy with the manually received incident data 126, indications of discrete blocks that are associated with a respective discrepancy and a member discrete block of a subset, that were not selected (e.g., by a weighting scheme) are provided at the display screen 116 with a visual feature that distinguishes the discrete blocks from other discrete blocks.

In some of these examples where a subset of the respective discrete blocks is associated with a same discrepancy with the manually received incident data 126, the method 300 may further comprise, the controller 218 and/or the call-handling device 102: reselecting a discrete block of the subset when a new discrete block is added to the subset. Hence, when discrete block is added to a cluster (e.g., as more of an audio stream 110 is received), a selection of a discrete block may again occur, which may result in the same discrete block of the cluster being selected, or another discrete block of the cluster, including, but not limited to, the new discrete block.

In some of these examples where a subset of the respective discrete blocks is associated with a same discrepancy with the manually received incident data 126 the selected discrete block may be selected based on a weighting scheme that includes assigning a higher weight to discrete blocks of the subset having one or more of: associated better audio quality relative to other discrete blocks of the subset; more than one discrepancy; an associated detail density that is denser relative to other discrete blocks of the subset; an associated longer audio portion length relative to other discrete blocks of the subset; and an associated time that is more recent relative to other discrete blocks of the subset.

Put another way, the weighting scheme may be based on one or more of: audio quality of an associated portion of an audio stream 110 in which a feature of the cluster is mentioned; a number of discrepancies of an associated portion of an audio stream 110 in which a feature of the cluster is mentioned; a length of an associated portion of an audio stream 110 in which a feature of the cluster is mentioned; detail density of the associated portion of an audio stream 110; recency of a discrete block, and the like.

For example, discrete blocks of a cluster having higher associated audio quality may be weighted higher than other discrete blocks of the cluster having lower associated audio quality. For example, the call-handling device 102 and/or the audio-stream processing engine 104 may be further configured to determine audio quality of discrete blocks, for example on a scale of 1 to 10 (e.g., with 1 being low and 10 being high), and the like, and audio quality may be determine based on one or more noise in audio associated with a discrete block, signal-to-noise ratio (SNR) associated with discrete block, and the like. Hence, discrete blocks of a cluster having higher associated audio quality as indicated on the scale may be weighted higher than other discrete blocks of the cluster having lower associated audio quality as indicated on the scale.

Furthermore, some discrete blocks of a cluster may be associated with more than one feature associated with a discrepancy, such as the “red sedan” and a description of a suspect that may have been erroneously transcribed. In some examples, discrete blocks having higher numbers of features with discrepancies may be weighted higher than discrete blocks having fewer numbers of features with discrepancies. Indeed, visually distinguishing discrete blocks having higher numbers of features associated with discrepancies at the display screen 116 may result in a more compact indications at the display screen of the discrepancies.

Similarly, some discrete blocks of a cluster may include more features (which may or not be associated with discrepancies) than other discrete blocks of the cluster. Associated portions of audio streams 110 of such discrete blocks with higher numbers of features may be easier for a listener (e.g., the dispatcher 114) to aurally parse than portions of audio streams 110 of discrete blocks of the cluster having fewer numbers of features. Hence, in some examples, discrete blocks having higher numbers of features may be weighted higher than discrete blocks having fewer numbers of features. Indeed, in some of these examples, discrete blocks a higher feature density (e.g., number of features per total number of words of a discrete block) may be weighted higher than discrete blocks a lower feature density.

Furthermore, some discrete blocks of a cluster may be associated with longer lengths of an associated portion of an audio stream 110 in which a feature of the cluster is mentioned, as compared to other discrete blocks of the cluster. Such longer length portions may be easier for a listener (e.g., the dispatcher 114) to aurally parse than shorter length portions. Hence, in some examples, discrete blocks having associated with longer lengths of an associated portion of an audio stream 110 in which a feature of the cluster is mentioned may be weighted higher than discrete blocks associated with shorter lengths of an associated portion of an audio stream 110 in which a feature of the cluster is mentioned.

In yet further examples, more recent discrete blocks of a cluster may be weighted higher than less recent discrete blocks. For example, as the visual indications 130 may be provided at the display screen 116 in real-time, more recent discrete blocks of a cluster may be more noticeable on the display screen 116 than less recent discrete blocks of the cluster, and/or, over time, a user 108 from which a respective audio stream 110 originated may better remember details of an incident. Again using the example of a “red sedan”, a “green sedan” and the erroneous “blue sedan”, when a less recent discrete block of an associated cluster indicates “A green sedan hit my car”, a more recent discrete block may indicate “No wait, it was a red sedan”. Hence, the most recent discrete block may be weighted higher than the less recent discrete block.

In a particular weighting scheme, discrete blocks of a cluster associated with higher audio quality may be first selected, and when a plurality of discrete blocks of the cluster have a same audio quality, one or more of numbers of respective discrepancies, lengths of portions of associated audio streams, feature density and recency may be used to weight the discrete blocks, with a highest weighted block being selected to represent the cluster.

However, any suitable weighting scheme is within the scope of the present specification.

In some examples, a detail may occur in a set of manually received incident data 126 that is not present in a transcription 128 of any discrete blocks of an associated audio stream 110.

To handle this situation, the method 300 may further comprise, the controller 218 and/or the call-handling device 102: when a discrepancy is found comprising a detail in the manually received incident data 126 that is not present in a transcription 128 of any discrete blocks of an associated audio stream 110, generating a placeholder discrete block comprising the detail and excluding audio data; comparing the placeholder discrete block with the discrete blocks of the associated audio stream 110; and when the placeholder discrete block is determined to be associated with details of one or more of the discrete blocks of the associated audio stream 110, visually distinguishing the one or more of the other discrete blocks of the associated audio stream 110 as including a discrepancy.

For example, manually received incident data 126 may mention a “blue van” and there may be no discrete blocks that indicate a van of any kind, or any type of vehicle that is blue. In this example, a placeholder discrete block may be generated without any timestamps, that includes the text “blue van”, and the placeholder discrete block may be compared with other discrete blocks to determine whether any of the other discrete blocks include a similar feature and/or a semantically related feature, such as a “red sedan” (e.g., both phrases mentions a color and a vehicle type). In this example, the placeholder discrete block may be combined with one or more previous discrete blocks that corresponds to the “red sedan” (e.g., to form a cluster, or the placeholder discrete block may be added to an existing cluster of other discrete blocks that mention a “red sedan”), and one of the one or more previous discrete block may be selected (e.g., using the aforementioned weighting scheme), and visually distinguished at the display screen 116.

In such examples, it is understood that the audio-stream processing engine 104 is configured (e.g., programmatically and/or using one or more machine learning algorithms, and the like) to identify features in the manually received incident data 126 that may be related to incidents, such as objects, people, addresses, and the like.

Similarly, in such examples, it is understood that the audio-stream processing engine 104 is configured (e.g., programmatically and/or using one or more machine learning algorithms, and the like) to compare such identified features in the manually received incident data 126 with features of the discrete blocks and associate them. For example, when two different vehicle types are identified in manually received incident data 126 and in one or more other discrete blocks, but similar or same vehicle types are not found in both the manually received incident data 126 and in one or more other discrete blocks, the audio-stream processing engine 104 may generate a placeholder discrete block that includes text identifying the vehicle type mentioned in the manually received incident data 126, and accordingly associate the placeholder discrete block with the one or more other discrete blocks where a different vehicle type is mentioned. Such an association between the placeholder discrete block and the one or more other discrete blocks may occur via an NLP engine, and the like, and/or a semantic similarity analysis engine, and the like, which may be a component of the audio-stream processing engine 104.

Alternatively, when the placeholder discrete block is determined not to be associated with the details of one or more of the discrete blocks of the associated audio stream 110, a notification may be provided at the display screen 116 to review an associated audio stream 110.

Put another way, in this example, such a notification may prompt the dispatcher 114 to review the manually received incident data 126 where a detail that does not occur in one or more of the discrete blocks as the dispatcher 114 may have erred and/or entered a detail in the manually received incident data 126 heard on an unrelated audio stream 110.

The method 300 may further comprise, the controller 218 and/or the call-handling device 102: delaying one or more of the comparing (of the block 310) and the visually distinguishing (of the block 314) by a given time period. For example, such a given time period may be 30 second, 1 minute, 2 minutes, amongst other possibilities, and may be selected (e.g., by an administrator of the system 100) to allow time for the dispatcher 114 to generate a set of manually received incident data 126.

The method 300 may further comprise, the controller 218 and/or the call-handling device 102: providing, at the display screen 116, within an indication of a discrete block with an associated discrepancy, a further indication of a position of audio in the discrete block associated with discrepancy. For example, when a discrete block includes a plurality of features, at least one of which is associated with a discrepancy, a particular feature associated with the discrepancy may be highlighted in the discrete block, and/or a time stamp of an associated audio stream 110 where the particular feature associated with the discrepancy occurs may be provided, and/or a link to the portion of the audio stream 110 where the particular feature associated with the discrepancy is mentioned may be provided, amongst other possibilities.

It is furthermore understood that different visual features may be used to distinguish between different indications at the display screen 116. For example, first indications of first discrete blocks that are associated with a discrepancy may be provided at the display screen 116 with a first visual feature. Put another way, the first visual feature indicates discrete blocks associated with discrepancies between information and/or features of a transcription 128 and/or a respective audio stream 110, and respective incident data 126.

Furthermore, second indications of second discrete blocks that may be not associated with a respective discrepancy, but which include details associated with the incident that may be the same as in the manually received incident data 126, may be provided at the display screen 116 with a second visual feature. Put another way, the second visual feature indicates discrete blocks associated with consistencies between information and/or features of a transcription 128 and/or a respective audio stream 110, and respective incident data 126.

Furthermore, third indications of third discrete blocks that may be not associated with a respective discrepancy, and which do not include any details associated with the incident, may be provided at the display screen 116 with a third visual feature. Put another way, the third visual feature indicates discrete blocks associated with information that is not pertinent to an incident. For example, such discrete blocks may include filler words (e.g., articles, connector words, exclamations, and the like, such as “the”, “and”, “or”, “whew”, “what”, and the like).

Furthermore, discrete blocks of clusters may be indicated in different ways for example to distinguish between a selected discrete block of a cluster and not selected discrete blocks of the cluster.

The various visual features may be different from each other and may comprise one or more of different respective colors, different shading types, different font colors, different font types, boxes formed from different respective line types, underlining using different respective line types, and/or combinations thereof, amongst other possibilities.

Attention is next directed to FIG. 1, FIG. 4, FIG. 5, FIG. 6, and FIG. 7, that depict aspects of the method 300.

Firstly, with brief reference back to FIG. 1, FIG. 1 depicts the call-handling device 102 handling (e.g., at the block 302 of the method 300) a plurality of audio streams 110 as well as transcribing (e.g., at the block 304 of the method 300) the audio streams 110 to generate the transcriptions 128 (e.g., as represented by a hollow arrow in FIG. 1).

Attention is next directed to FIG. 4, which depicts an example of parsing (e.g., at the block 306 of the method 300, as represented by a hollow arrow in FIG. 4), an audio stream 110 and an associated transcription 128 into discrete blocks 402-1, 402-2, 402-3, 402-4, 402-5, 402-6, 402-7, 402-8, 402-9 (e.g., discrete blocks 402 and/or a discrete block 402).

While not depicted, it is understood that the call-handling device 102 (e.g., via the audio-stream processing engine 104) is implementing the process depicted in FIG. 4. Indeed, it is understood that the call-handling device 102 (e.g., via the audio-stream processing engine 104) is implementing the processes depicted in FIG. 4, FIG. 5, FIG. 6, and FIG. 7.

While FIG. 4 depicts only one audio stream 110 and an associated transcription 128, it is understood that the depicted parsing may occur for the plurality of audio streams 110.

As depicted, the transcription 128 comprises text “I'm calling about a car accident. A green sedan hit my car. It was driven by a man with blonde hair. No wait, it was a red sedan. Yes a red sedan. At 123 Main Street”, which is understood to be a transcription of voice data in the depicted audio stream 110, which may be played at the speaker 120 of the terminal 112 so that the dispatcher 114 may generate an incident report from the voice data, for example that may include manually received incident data 126 also depicted in FIG. 4.

The transcription 128 includes various details and/or features, some of which are related to an incident of a “car accident”, while others are merely filler words, and the like, and it is understood that the call-handling device 102 and/or the audio-stream processing engine 104 parses the transcription 128 using an NLP engine and/or algorithm to parse the words of the transcription 128 into the discrete blocks 402, which may also include timestamps from the associated audio stream 110. As depicted, the discrete blocks 402 also include an indication of audio quality (e.g., “AQ”), on a scale of 1 to 10 (with 1 being relatively lowest audio quality and 10 being relatively highest audio quality).

For example, the discrete block 402-1 comprises the first three words of the transcription 128 of “I'm calling about”, as well timestamps of the “Start” and “Stop” times of where the words occur in the associated audio stream 110, such as, respectively, “Start” of “0 s” and “Stop” of “1 s” (e.g., where “s” stands for “seconds”). Audio quality has been determined to be “8”.

For example, the discrete block 402-2 comprises the next three words of the transcription 128 of “a car accident”, as well timestamps of the “Start” and “Stop” times of where the words occur in the associated audio stream 110, such as, respectively, “Start” of “1 s” and “Stop” of “2 s”. Audio quality has been determined to be “8”.

Similarly, the discrete block 402-3 comprises the next five words of the transcription 128 of “A green sedan hit my car”, as well timestamps of the “Start” and “Stop” times of where the words occur in the associated audio stream 110, such as, respectively, “Start” of “3 s” and “Stop” of “5 s”. Audio quality has been determined to be “8”.

Similarly, the discrete block 402-4 comprises the next six words of the transcription 128 of “It was driven by a man”, as well timestamps of the “Start” and “Stop” times of where the words occur in the associated audio stream 110, such as, respectively, “Start” of “5 s” and “Stop” of “6 s”. Audio quality has been determined to be “8”.

Similarly, the discrete block 402-5 comprises the next three words of the transcription 128 of “with blonde hair”, as well timestamps of the “Start” and “Stop” times of where the words occur in the associated audio stream 110, such as, respectively, “Start” of “6 s” and “Stop” of “7 s”. Audio quality has been determined to be “7” (e.g., SNR of the associate audio stream 110 may have decreased).

Similarly, the discrete block 402-6 comprises the next two words of the transcription 128 of “No wait”, as well timestamps of the “Start” and “Stop” times of where the words occur in the associated audio stream 110, such as, respectively, “Start” of “7 s” and “Stop” of “8 s”. Audio quality has been determined to be “9” (e.g., SNR of the associate audio stream 110 may have increased).

Similarly, the discrete block 402-7 comprises the five words of the transcription 128 of “It was a red sedan”, as well timestamps of the “Start” and “Stop” times of where the words occur in the associated audio stream 110, such as, respectively, “Start” of “8 s” and “Stop” of “10 s”. However, in contrast to the previous discrete blocks 402, the discrete block 402-7 includes a further time stamp of “8.7 s” indicating where a detail of the discrete block 402-7 begins in the associated audio stream 110. For example, the detail of a “red sedan” may begin in the associated audio stream 110 at 8.7 seconds. Audio quality has been determined to be “8”.

Similarly, the discrete block 402-8 comprises the next four words of the transcription 128 of “Yes a red sedan”, as well timestamps of the “Start” and “Stop” times of where the words occur in the associated audio stream 110, such as, respectively, “Start” of “9 s” and “Stop” of “13 s”. Similar to the discrete block 402-7, the block 402-8 includes a further time stamp of “12.5 s” indicating where a detail of the discrete block 402-8 begins in the associated audio stream 110. For example, the detail of a “red sedan” may begin in the associated audio stream 110 at 12.5 seconds. Audio quality has been determined to be “9”.

Similarly, the discrete block 402-9 comprises the next four words of the transcription 128 of “At 123 Main Street” (e.g., presuming “123” is word), as well timestamps of the “Start” and “Stop” times of where the words occur in the associated audio stream 110, such as, respectively, “Start” of “13 s” and “Stop” of “14 s”. Audio quality has been determined to be “9”.

While time stamps of where details of other discrete blocks 402 are not depicted, they may nonetheless be present. Alternatively, or in addition, time stamps of such details may be provided only for discrete blocks 402 associated with lengths of portions of associated audio streams 110 over a threshold time period such as 1 second, 2 seconds, 3 seconds, amongst other possibilities. For example, using a threshold time period of 1 second, only the discrete blocks 402-7, 402-8 associated with lengths of portions of associated audio streams 110 over 1 second (e.g., 2 seconds and 3 seconds respectively).

Furthermore, it is understood that the depicted data structure of the discrete blocks 402 may include any other suitable information that may include, but is not limited to, a transcription score (e.g., a rating of accuracy of the respective text), assigned visual indications (e.g., described with respect to FIG. 6 and FIG. 7), and the like. Indeed, the transcription score may also be used in the aforementioned weighting scheme, and may comprise a machine learning score from a voice-to-text machine learning algorithm, and the like, used to generate respective text of a discrete block 402. For example, discrete blocks of a cluster having a higher transcription score may be weighted more than other discrete blocks having a lower transcription score.

Indeed, it is understood that the parsing depicted in FIG. 4, and identifying within the discrete blocks 402, information associated with an incident (e.g., at the block 308 of the method 300) may occur concurrently such that, for example, features and/or details such as “car accident”, “green sedan”, “man”, “blonde hair”, and “red sedan” are identified as information associated with an incident.

FIG. 4 further depicts an example of associated manually received incident data 126 that may be manually recorded by the dispatcher 114 when listening to the associated audio stream 110.

For example, as depicted, the manually received incident data 126 includes an incident type of “Car Accident”, details of a suspect such as a gender of “Male”, distinguishing features of “Blonde Hair” and “Blue Hat”, and a description of a vehicle driven by the suspect of “Blue Sedan”. The manually received incident data 126 further includes, however, a blank field for an “Address” of the incident, which is not been populated. While information for the blank field has not yet been manually received, it is understood that that the presence of the blank field for an “Address” indicates that information indicating an address should be manually received.

Attention is next directed to FIG. 5 which depicts an example of comparing (at the block 310 of the method 300), the information of the discrete blocks 402 determined to be associated with an incident with the manually received incident data 126, to identify discrepancies therebetween. The comparing is represented in FIG. 5 as a double ended hollow arrow between discrete blocks 402 and the manually received incident data 126.

For example, as depicted, the call-handling device 102 may compare the respective portions of the transcription 128 of the discrete blocks 402 with the manually received incident data 126 to determine consistencies and discrepancies therebetween, as well whether any of the discrete blocks 402 include no relevant details.

In particular, as depicted, the call-handling device 102 may add respective tags 500 to the discrete blocks 402 indicating whether a respective discrete block 402 include no relevant details (e.g., tags 500-1, 500-6 of “No Detail” for the discrete blocks 402-1, 402-6), consistent details (e.g., tags 500-2, 500-4, 500-5 of “Consistent” for the discrete blocks 402-2, 402-4, 402-5), and or discrepancies (e.g., tags 500-3, 500-7, 500-8, 500-9 of “Discrepancy” for the discrete blocks 402-3, 402-7, 402-8, 402-9).

For example, the discrete blocks 402-1, 402-6 are tagged with “No Detail” as the discrete blocks 402-1, 402-6 are associated with filler words such as “I'm calling about” and “No wait”, which provide no features and/or details of objects or people, and the like associated with the incident of a “Car Accident”.

The discrete blocks 402-2, 402-4, 402-5 are tagged with “Consistent” as the discrete blocks 402-2, 402-4, 402-5 are consistent with details of the manually received incident data 126. For example, “a car accident” of the discrete block 402-2 is consistent with the incident type of a “Car Accident” of the manually received incident data 126. Similarly, a detail of “man” of “It was driven by a man” of the discrete block 402-4 is consistent with the gender of a “Male” of the manually received incident data 126. Similarly, a detail of a “blonde hair” of “with blonde hair” of the discrete block 402-5 is consistent with the distinguishing feature of a “Blonde Hair” of the manually received incident data 126.

The discrete blocks 402-3, 402-7, 402-8, 402-9 are tagged with “Discrepancy” as the discrete blocks 402-3, 402-7, 402-8, 402-9 are inconsistent with details of the manually received incident data 126. For example, a detail of “green sedan” of “A green sedan hit my car” of the discrete block 402-3 is inconsistent with the suspect vehicle type of a “Blue Sedan” of the manually received incident data 126. Similarly, a detail of “red sedan” of “It was a red sedan” of the discrete block 402-7 is inconsistent with the suspect vehicle type of a “Blue Sedan” of the manually received incident data 126. Similarly, a detail of “red sedan” of “Yes a red sedan” of the discrete block 402-8 is inconsistent with the suspect vehicle type of a “Blue Sedan” of the manually received incident data 126.

Furthermore, the presence of an address of “123 Main Street” at the discrete block 402-9, and the absence of an address at the “Address” field of the manually received incident data 126 is yet a further example of a discrepancy and/or inconsistency between the information of the discrete blocks 402 and the manually received incident data 126. Indeed, according to the present specification, a detail and/or information associated with the incident that is present in the discrete blocks 402, but absent from the manually received incident data 126 (e.g., whether or not a corresponding field is present for the detail) is understood to represent a discrepancy therebetween.

As also depicted in FIG. 5, the call-handling device 102 may identify a feature and/or detail of “Blue Hat” in the manually received incident data 126, and determine that the detail of “Blue Hat” is not present in any text of the discrete blocks 402, and responsively generate a placeholder discrete block 502 comprising the detail of “Blue Hat”, the placeholder discrete block 502 excluding any audio data (e.g., as such start and stop timestamps, and the like). The placeholder discrete block 502 may represent a discrepancy between the discrete blocks 402 and the manually received incident data 126.

FIG. 5 further depicts an example of a cluster 504. For example, the discrete blocks 402-3, 402-7, 402-8 are associated with a same (or similar) discrepancy with the detail of a “Blue Sedan” of the manually received incident data 126, and hence may be logically grouped together at the cluster 504, and weighted, as has been previously described.

For example, as depicted the discrete block 402-3 may have a lowest weight of “2” based on length, recency, and/or audio quality. For example, the discrete block 402-3 may have lower audio quality than the discrete block 402-8, at “1 second” a portion of the associated audio stream 110 may be the shortest of the respective portions of the associated audio stream 110 of the discrete blocks 402-3, 402-7, 402-8, and may be the least recent of the discrete blocks 402-3, 402-7, 402-8.

Similarly, as depicted the discrete block 402-7 may have a second highest weight of “7” based on length, recency, and/or audio quality. For example, the discrete block 402-7 may have lower audio quality than the discrete block 402-8, at “2 seconds” a portion of the associated audio stream 110 may have a length that is between respective lengths of the respective portions of the associated audio stream 110 of the discrete blocks 402-3, 402-7, 402-8, and may be the second most recent of the discrete blocks 402-3, 402-7, 402-8.

Similarly, as depicted the discrete block 402-8 may have a second highest weight of “10” based on length, recency, and/or audio quality. For example, the discrete block 402-7 may have the highest audio quality of the discrete blocks 402-3, 402-7, 402-8, a portion of the associated audio stream 110 may have a length that is the longest of respective lengths of the respective portions of the associated audio stream 110 of the discrete blocks 402-3, 402-7, 402-8, and may be the most recent of the discrete blocks 402-3, 402-7, 402-8.

Hence, the highest weighted the discrete block 402-8 may be selected to represent the cluster 504 as is next described.

It is further understood that, as discrete blocks 402 are received and added to the cluster 504, a discrete block 402 of the cluster 504 may be re-selected.

Attention is next directed to FIG. 6, which depicts the interface 122 at the display screen 116 after the call-handling device 102 provides (e.g., at the block 312 of the method 300) at the display screen 116 respective visual indications 130 of the respective discrete blocks 402 of the audio streams 110. FIG. 6 further depicts the speaker 120, and while other components of the terminal 112 are not depicted, they are nonetheless understood to be present.

FIG. 6 further depicts the interface 122 at the display screen 116 after the call-handling device 102 visually distinguishes (e.g., at the block 314 of the method 300), at the display screen 116, the visual indications 130 of the respective discrete blocks 402 of the audio streams 110 associated with the discrepancies from other discrete blocks 402 not associated with the discrepancies.

For clarity, in FIG. 6, respective text of the discrete blocks 402 are provided in order so that the display screen 116 renders the text of the transcription 128, and the respective text is indicated with respect to the component number of a respective discrete block 402.

However, each set of respective text is surrounded by a respective box of various types that represent the various respective visual indications 130, and which may depend on a respective tag 500 and/or whether or not associated discrete blocks 402 are part of the cluster 504.

For example, starting with the text of “Yes a red sedan” of the discrete block 402-8, a box 601-2 of a relatively thick line width surrounds the text of “Yes a red sedan”, indicating that the text of “red sedan” represents a discrepancy with “Blue Sedan” of the manually received incident data 126, as indicated by the tags 500-3, 500-7, 500-8.

Similarly, a box 601-2 of the same relatively thick line width as the box 601-2 surrounds the text of “At 123 Main Street”, indicating that the text of “123 Main Street” represents a discrepancy with an absence of information at the “Address” field of the manually received incident data 126, as indicated by the tag 500-9.

In contrast, text of “a car accident”, and “It was driven by a man” and “with blonde hair” of the discrete blocks 402-2, 402-4, 402-5, boxes 602 of a reduced line width, relative to the boxes 601, surrounds the respective text, indicating that the respective text is consistent with the manually received incident data 126,, as indicated by the tags 500-2, 500-4, 500-5.

In further contrast, text of “I'm calling about”, and “No wait” of the discrete blocks 402-1, 402-6, boxes 603 of yet a further a reduced line width, relative to the box 602, surrounds the respective text, indicating that the respective text includes no pertinent details, as indicated by the tags 500-1, 500-6.

In further contrast, text of “A green sedan hit my car”, and “It was a red sedan” of the discrete blocks 402-3, 402-7, boxes 604 of a broken line, surround the respective text, indicating that the discrete blocks 402-3, 402-7 are part of the cluster 504 that includes the selected discrete block 402-8.

Hence, the boxes 601, 602, 603, 604 represent first, second, third and fourth visual features of first, second, third and fourth visual indications 130. Indeed, indications of line width and/or line type of the boxes 601, 602, 603, 604 may be added to the data structure of the respective discrete blocks 402

Returning to the visual indications 130 of the discrete blocks 402 provided at the display screen 116, it is further understood that the boxes 601, 602, 603, 604 may comprise electronic buttons, which, when actuated, cause an associated portion of audio from the associated audio stream 110 to be played at the speaker 120. For example, as depicted the dispatcher 114 may operate the terminal 112 (e.g., via the input device 118), to use a pointer 606 actuate the electronic button represented by the box 601-1, which causes the speaker 120 to play the associated portion of the audio stream 110 of the discrete block 402-8 (e.g., see FIG. 7), for example, based on the respective start and stop timestamps of the discrete block 402-8.

However, as also depicted at the text of the discrete block 402-8, an indicator 605 of a timestamp position of the detail of a “red sedan” is provided, for example at a position along the respective text of the discrete block 402-8 that may correspond to the time stamp of “12.5”. No similar indicator is provided for the text of the discrete block 402-7 (e.g., having a detail time stamp of “8.7 s”), as the discrete block 402-7 is a member of the cluster 504 that is not selected. Put another way, in some examples, when visual indications 130 of discrete blocks 402 of clusters are provided at the display screen 116, an indicator of a timestamp position of associated details may be provided only for a selected discrete block 402. However, in other examples, when visual indications 130 of discrete blocks 402 of clusters are provided at the display screen 116, an indicator of a timestamp position of associated details may be provided for all discrete block 402 having such detail timestamps may be provided.

In alternative examples, rather than use the pointer 606 to actuate the electronic button represented by the box 601-1, the pointer 606 may be used to actuate the indicator 605, which causes the speaker 120 to play the associated portion of the audio stream 110 (e.g., see FIG. 7), but starting from the detail timestamp associated with the indicator 605. Put another way, the indicator 605 also comprises an indication of the discrete block 402-8, and is also provided as an electronic button, but actuation thereof causes the speaker 120 to play the associated portion of the audio stream 110 of the discrete block 402-8 (e.g., see FIG. 7) starting from the respective detail timestamp (e.g., of 12.5 seconds and ending at the “Stop” timestamp).

As also depicted in FIG. 6, a representation of the manually received incident data 126 may also be provided at the display screen 116.

As depicted, the distinguishing feature of a “Blue Hat” is shown in the manually provided incident data 126. The text of “Blue Hat” of the associated placeholder discrete block 502 may be compared with text of the other discrete blocks 402 to determine whether a “Blue Hat” is associated details of the other discrete blocks 402. Presuming a result of such a determination is “No”, then, as depicted, the call-handling device 102 provides, at the display screen 116, a notification 608 to review the associated audio stream 110 because the “Transcription does not mention a hat or a blue hat”. The notification 608 may cause the dispatcher 114 to operate the terminal 112 to play the associated audio stream 110 to determine if the dispatcher 114 erroneously recorded “Blue Hat” in the manually received incident data 126.

Hence, as depicted in FIG. 6, the interface 122 shows three possible errors made by the dispatcher 114 when populating the manually received incident data 126: a possibly erroneous entry of a “Blue Sedan”; a missing entry of “123 Main Street”; and a possibly erroneous entry of a “Blue Hat”.

As also depicted in FIG. 6, the display screen 116 may be controlled to render an electronic button 610, which, when actuated, confirms to the call-handling device 102 that the details of the manually received incident data 126 has been corrected and/or confirmed as accurate by the dispatcher 114.

Turning now to FIG. 7, it is understood the electronic button represented by the box 601-1 associated with the discrete block 402-8 has been actuated via the pointer 606, and hence the speaker 120 is controlled to emit sound 702 of “Yes a red sedan” corresponding to the portion of the associated audio stream 110 corresponding to the discrete block 402-8. In response, the dispatcher 126 has corrected the manually received incident data 126 to read “Red Sedan” rather than “Blue Sedan”.

Similarly, it is understood the electronic button represented by the box 601-2 associated with the discrete block 402-9 has been actuated via the pointer 606, and hence the speaker 120 is controlled to emit sound 704 of “At 123 Main Street” corresponding to the portion of the associated audio stream 110 corresponding to the discrete block 402-9. In response, the dispatcher 126 has added the address of “123 Main Street” to the manually received incident data 126 at the corresponding “Address” field.

As such the tags 500 may be redetermined, with the tags 500-3, 500-7, 500-8, 500-9 changing from “Discrepancy” to “Consistent”, and, as depicted, the call-handling device 102 responsively changes instances of the boxes 601, 604 to instances of boxes 602, indicating that the discrepancy was resolved.

Furthermore, as depicted, the distinguishing feature of “Blue Hat” has been removed from the manually received incident data 126, for example after confirming that the associated audio stream 110 made no mention of a blue hat.

As also depicted in FIG. 7, the electronic button 610 is being actuated via the pointer 606 to confirm that the details of the manually received incident data 126 are accurate and/or have been corrected. Actuation of the electronic button 610 may cause an associated incident report to be updated automatically based on the corrected manually received incident data 126.

In this manner, the manually received incident data 126 may be corrected, and the dispatcher 114 may dispatch a first responder to a scene of the incident accordingly. Alternatively, a first responder may be automatically dispatched to the scene of the incident, for example when the electronic button 610 is actuated.

As should be apparent from this detailed description above, the operations and functions of electronic computing devices described herein are sufficiently complex as to require their implementation on a computer system, and cannot be performed, as a practical matter, in the human mind. Electronic computing devices such as set forth herein are understood as requiring and providing speed, accuracy and complexity management that are not obtainable by human mental steps, in addition to the inherently digital nature of such operations (e.g., a human mind cannot interface directly with RAM or other digital storage, cannot control visual indications at a display screen, cannot operate machine learning algorithms, and the like).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). Similarly the terms “at least one of” and “one or more of”, without a more limiting modifier such as “only one of”, and when applied herein to two or more subsequently defined options such as “at least one of A or B”, or “one or more of A or B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context, in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
concurrently handling, via a call-handling device, audio streams, the call-handling device communicatively coupled to a display screen, and an input device;
transcribing, via the call-handling device, the audio streams;
parsing, via the call-handling device, the audio streams and associated transcriptions into discrete blocks;
identifying, via the call-handling device, within the discrete blocks, information associated with an incident;
comparing, via the call-handling device, the information and manually received incident data to identify discrepancies therebetween;
providing, via the call-handling device, at the display screen, respective visual indications of respective discrete blocks of the audio streams; and
visually distinguishing, via the call-handling device, at the display screen, the respective visual indications of the respective discrete blocks of the audio streams associated with the discrepancies from other discrete blocks not associated with the discrepancies.

2. The method of claim 1, wherein the call-handling device is further communicatively coupled to a speaker and the method further comprises:
providing the visual indications of the respective discrete blocks of the audio streams at the display screen as respective electronic buttons;
when input is received at an electronic button of a given discrete block associated with a discrepancy, playing, at the speaker, associated audio from an audio stream at the speaker; and,
after playing the associated audio, again comparing the information associated with the given discrete block with the manually received incident data, and
when the discrepancy between the information associated with the given discrete block and the manually received incident data has been resolved, controlling a visual indication of the given discrete block at the display screen to change to indicate that the discrepancy is no longer present.

3. The method of claim 1, further comprising:
when a subset of the respective discrete blocks is associated with a same discrepancy with the manually received incident data, selecting one discrete block of the subset to represent the subset as having the same discrepancy; and
visually distinguishing, at the display screen, an indication of the selected discrete block of the subset from other discrete blocks of the subset.

4. The method of claim 3, further comprising:
reselecting a discrete block of the subset when a new discrete block is added to the subset.

5. The method of claim 3, wherein the selected discrete block is selected based on a weighting scheme that includes assigning a higher weight to discrete blocks of the subset having one or more of:
associated better audio quality relative to other discrete blocks of the subset;
more than one discrepancy;
an associated detail density that is denser relative to other discrete blocks of the subset;
an associated longer audio portion length relative to other discrete blocks of the subset; and
an associated time that is more recent relative to other discrete blocks of the subset.

6. The method of claim 5, wherein indications of discrete blocks that are associated with a respective discrepancy and a member discrete block of a subset, that were not selected by the weighting scheme are provided at the display screen with a visual feature that distinguishes the discrete blocks from other discrete blocks.

7. The method of claim 1, further comprising:
when a discrepancy is found comprising a detail in the manually received incident data that is not present in a transcription of any discrete blocks of an associated audio stream, generating a placeholder discrete block comprising the detail and excluding audio data;
comparing the placeholder discrete block with the discrete blocks of the associated audio stream; and
when the placeholder discrete block is determined to be associated with details of one or more of the discrete blocks of the associated audio stream, visually distinguishing the one or more of the other discrete blocks of the associated audio stream as including a discrepancy; or
when the placeholder discrete block is determined not to be associated with the details of one or more of the discrete blocks of the associated audio stream, provide a notification at the display screen to review an associated audio stream.

8. The method of claim 1, further comprising:
delaying one or more of the comparing and the visually distinguishing by a given time period.

9. The method of claim 1, further comprising:
providing, at the display screen, within an indication of a discrete block with an associated discrepancy, a further indication of a position of audio in the discrete block associated with discrepancy.

10. The method of claim 1, wherein:
first indications of first discrete blocks that are associated with a discrepancy are provided at the display screen with a first visual feature;
second indications of second discrete blocks that are not associated with a respective discrepancy, but which include details associated with the incident that are the same as in the manually received incident data, are provided at the display screen with a second visual feature; and
third indications of third discrete blocks that are not associated with a respective discrepancy, and which do not include any details associated with the incident, are provided at the display screen with a third visual feature.

11. A computing device comprising:
a controller communicatively coupled to a display screen, and an input device; and
a computer-readable storage medium having stored thereon program instructions that, when executed by the controller, causes the controller to perform a set of operations comprising:
concurrently handling audio streams;
transcribing the audio streams;
parsing the audio streams and associated transcriptions into discrete blocks;
identifying, within the discrete blocks, information associated with an incident;
comparing the information and manually received incident data to identify discrepancies therebetween;
providing, at the display screen, respective visual indications of respective discrete blocks of the audio streams; and
visually distinguishing, at the display screen, the respective visual indications of the respective discrete blocks of the audio streams associated with the discrepancies from other discrete blocks not associated with the discrepancies.

12. The computing device of claim 11, wherein the controller is further communicatively coupled to a speaker and the set of operations further comprises:
providing the visual indications of the respective discrete blocks of the audio streams at the display screen as respective electronic buttons;
when input is received at an electronic button of a given discrete block associated with a discrepancy, playing, at the speaker, associated audio from an audio stream at the speaker; and,
after playing the associated audio, again comparing the information associated with the given discrete block with the manually received incident data, and
when the discrepancy between the information associated with the given discrete block and the manually received incident data has been resolved, controlling a visual indication of the given discrete block at the display screen to change to indicate that the discrepancy is no longer present.

13. The computing device of claim 11, wherein the set of operations further comprises:
when a subset of the respective discrete blocks is associated with a same discrepancy with the manually received incident data, selecting one discrete block of the subset to represent the subset as having the same discrepancy; and
visually distinguishing, at the display screen, an indication of the selected discrete block of the subset from other discrete blocks of the subset.

14. The computing device of claim 13, wherein the set of operations further comprises:
reselecting a discrete block of the subset when a new discrete block is added to the subset.

15. The computing device of claim 13, wherein the selected discrete block is selected based on a weighting scheme that includes assigning a higher weight to discrete blocks of the subset having one or more of:
associated better audio quality relative to other discrete blocks of the subset;
more than one discrepancy;
an associated detail density that is denser relative to other discrete blocks of the subset;
an associated longer audio portion length relative to other discrete blocks of the subset; and
an associated time that is more recent relative to other discrete blocks of the subset.

16. The computing device of claim 15, wherein indications of discrete blocks that are associated with a respective discrepancy and a member discrete block of a subset, that were not selected by the weighting scheme are provided at the display screen with a visual feature that distinguishes the discrete blocks from other discrete blocks.

17. The computing device of claim 11 wherein the set of operations further comprises:
when a discrepancy is found comprising a detail in the manually received incident data that is not present in a transcription of any discrete blocks of an associated audio stream, generating a placeholder discrete block comprising the detail and excluding audio data;
comparing the placeholder discrete block with the discrete blocks of the associated audio stream; and
when the placeholder discrete block is determined to be associated with details of one or more of the discrete blocks of the associated audio stream, visually distinguishing the one or more of the other discrete blocks of the associated audio stream as including a discrepancy; or
when the placeholder discrete block is determined not to be associated with the details of one or more of the discrete blocks of the associated audio stream, provide a notification at the display screen to review an associated audio stream.

18. The computing device of claim 11, wherein the set of operations further comprises:
delaying one or more of the comparing and the visually distinguishing by a given time period.

19. The computing device of claim 11, wherein the set of operations further comprises:
providing, at the display screen, within an indication of a discrete block with an associated discrepancy, a further indication of a position of audio in the discrete block associated with discrepancy.

20. The computing device of claim 11, wherein:
first indications of first discrete blocks that are associated with a discrepancy are provided at the display screen with a first visual feature;
second indications of second discrete blocks that are not associated with a respective discrepancy, but which include details associated with the incident that are the same as in the manually received incident data, are provided at the display screen with a second visual feature; and
third indications of third discrete blocks that are not associated with a respective discrepancy, and which do not include any details associated with the incident, are provided at the display screen with a third visual feature.
